(19) United States
(12) Patent Application Publication
(10) Pub. No.: US 2019/0107126 A1
(43) Pub. Date: Apr. 11, 2019

(54) Near Isothermal Gas Compression

(71) Applicants: Larry Baxter, Orem, UT (US); Nathan Davis, Bountiful, UT (US)

(72) Inventors: Larry Baxter, Orem, UT (US); Nathan Davis, Bountiful, UT (US)

(21) Appl. No.: 15/728,787

(22) Filed: Oct. 10, 2017

(51) Int. Cl. F15B 3/00

(52) U.S. Cl. CPC F15B 3/00; F04B 41/02

(57) ABSTRACT

Devices, systems, and methods for compressing a gas are disclosed. A low-pressure gas is drawn into a vessel through a source gas inlet. The source gas inlet and a liquid gas outlet are sealed. A liquid is pumped into the vessel through a liquid inlet such that the low-pressure gas is compressed to produce a high-pressure gas. The liquid inlet is sealed. A destination gas outlet is opened and the high-pressure gas is passed out of the vessel. The destination gas outlet is sealed. The source gas inlet is opened. A liquid outlet is opened and the liquid is removed out of the vessel such that the low-pressure gas is drawn into the vessel as the liquid is removed from the vessel.

### GOVERNMENT INTEREST STATEMENT

This invention was made with government support under DE-FE0028697 awarded by the Department of Energy. The government has certain rights in the invention.

### BACKGROUND

Isothermal gas compressors require significantly less energy than adiabatic compressors operating over the same pressure ratio. However, it is difficult to build a compressor from traditional turbomachinery parts that can transfer heat fast enough to maintain isothermal conditions. Generally, a multi-stage compressor with inter-stage cooling finds application where energy efficiency is important. These, however, require complex plumbing and often awkward heat exchanger arrangements. A device, system, and method for accomplishing isothermal gas compression without these limitations would be beneficial.

### SUMMARY

Devices, systems, and methods for compressing a gas are disclosed. A low-pressure gas is drawn into a vessel through a source gas inlet. The source gas inlet and a liquid gas outlet are sealed. A liquid is pumped into the vessel through a liquid inlet such that the low-pressure gas is compressed to produce a high-pressure gas. The liquid inlet is sealed. A destination gas outlet is opened and the high-pressure gas is passed out of the vessel. The destination gas outlet is sealed. The source gas inlet is opened. A liquid outlet is opened and the liquid is removed out of the vessel such that the low-pressure gas is drawn into the vessel.

The compression may occur substantially isothermally.

The liquid inlet may be a spray nozzle, the spray nozzle causing the liquid entering the vessel to form a spray. The gas may be a vapor and the liquid may strip the vapor from the gas.

The vessel may be a plurality of vessels and the high-pressure gas may be passed out of the plurality of vessels staggered such that each of the plurality of vessels passes the high-pressure gas out at off-set times to produce a flow rate of the high-pressure gas that remains substantially steady.

The vessel may be a plurality of vessels arranged in series with the destination gas outlet of a previous vessel of the plurality of vessels being the source gas outlet for a next vessel of the plurality of vessels such that a final pressure of each of the plurality of vessels is higher than a final pressure of the previous vessel of the plurality of vessels.

The source gas inlet and the destination gas outlet may meet at a three-way valve. The liquid inlet and the liquid outlet may meet at a three-way valve.

The vessel may have an inverse boot. The vessel may have a mist eliminator before the destination gas outlet. The source gas inlet, the destination gas outlet, the liquid inlet, and the liquid outlet may have control valves.

The liquid may be water, liquid ammonia, hydrocarbons, cryogenic liquids, or combinations thereof.

### BRIEF DESCRIPTION OF THE DRAWINGS

In order that the advantages of the described devices, systems, and methods will be readily understood, a more particular description of the described devices, systems, and methods briefly described above will be rendered by reference to specific embodiments illustrated in the appended drawings. Understanding that these drawings depict only typical embodiments of the described devices, systems, and methods and are not therefore to be considered limiting of its scope, the devices, systems, and methods will be described and explained with additional specificity and detail through use of the accompanying drawings, in which:

FIG. 1 shows a process flow diagram of a horizontal spray tower with peripheral unit operations.

FIG. 2 shows a process flow diagram of three horizontal spray towers in parallel with peripheral unit operations.

FIG. 3 shows a process flow diagram of a vertical spray tower with peripheral unit operations.

FIG. 4 shows a process flow diagram of three vertical spray towers in parallel with peripheral unit operations.

FIG. 5 shows a process flow diagram of three vertical spray towers in series with peripheral unit operations.

FIG. 6 shows a process flow diagram of three vertical spray towers in series with peripheral unit operations.

### DETAILED DESCRIPTION

It will be readily understood that the components of the described devices, systems, and methods, as generally described and illustrated in the Figures herein, could be arranged and designed in a wide variety of different configurations. Thus, the following more detailed description of the embodiments of the described devices, systems, and methods, as represented in the Figures, is not intended to limit the scope of the described devices, systems, and methods, as claimed, but is merely representative of certain examples of presently contemplated embodiments in accordance with the described devices, systems, and methods.

Pressurizing gases is a challenge in all industries. The cost and size of traditional compressors increases exponentially as pressure requirements increase. Efficiencies of compressors are also not very high. Compressors typically are operated adiabatically since the time scale of compression is insufficient for heat exchange with the environment. Cumbersome indirect-contact heat exchangers can be added to these compressors to approximate isothermal compression, but are generally not successful. The devices, systems, and methods described herein can achieve isothermal conditions or near-isothermal conditions during gas compression. The near-isothermal conditions involved are defined as follows. The temperature rise of a gas in the devices, methods, and systems disclosed herein is at least less than half, and preferably less than a tenth, of the temperature rise of an adiabatic, isentropic compression of the gas to the same pressure. Further, a traditional compressor will always have a greater temperature rise than an adiabatic, isentropic compression. The devices, systems, and methods use liquid pumps to boost the pressure. Liquid pumps are significantly less expensive and can be significantly more efficient than compressors. The liquid that provides the compression also absorbs the heat produced by compressing the gas, resulting in the substantially isothermal compression. This decreases the energy required to compress the gas compared to adiabatic or staged compression. Pumps generally also have higher efficiencies than compressors and are much cheaper and simpler.

As an extra benefit, the devices, methods, and systems disclosed provide a safer compression system than traditional compression systems. At high pressures, the vessel contains relatively small volumes of gas and large volumes of liquid, which translates to much lower total stored energy than if it were all gas.

Combustion flue gas consists of the exhaust gas from a fireplace, oven, furnace, boiler, steam generator, or other combustor. The combustion fuel sources include coal, hydrocarbons, and bio-mass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The method disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

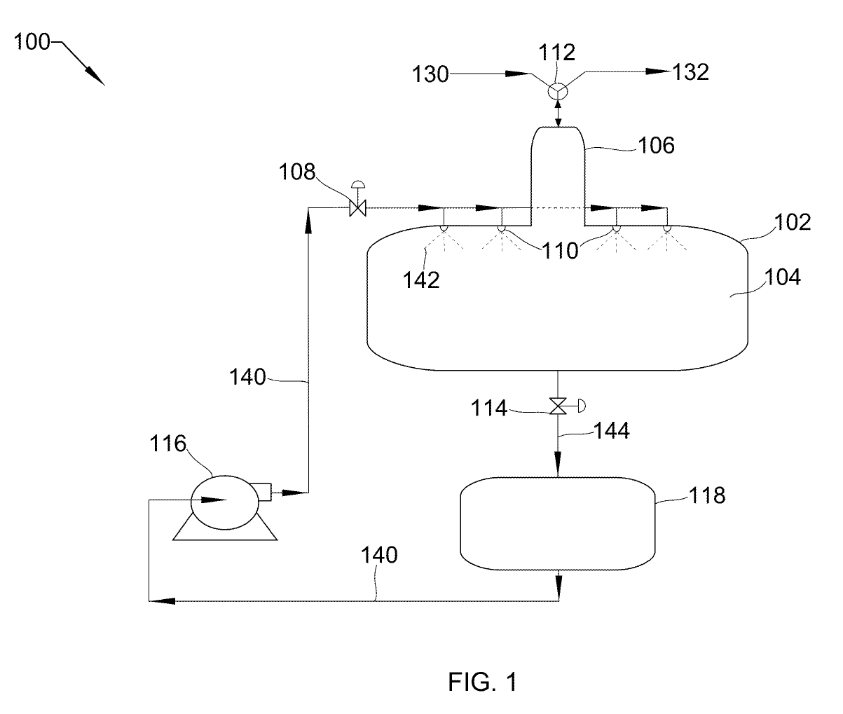

Referring now to FIG. 1, FIG. 1 shows a process flow diagram 100 of a horizontal spray tower 102 with peripheral unit operations that that may be used in the described devices, systems, and methods. Horizontal spray tower 102 consists of cavity 104, inverse-boot 106, liquid inlet valve 108, spray nozzles 110, gas inlet/outlet valve 112, and liquid outlet valve 114. In some embodiments, gas inlet/outlet valve 112 is a three-way valve. In other embodiments, Gas inlet/outlet valve could be two separate valves on the incoming and outgoing gas lines. Inverse boot 106 is a top section of horizontal spray tower 102 having a much smaller cross-sectional area than the lower section, allowing high-pressure gas 132 to occupy a space small enough to effectively manage its flow. In some embodiments, inverse-boot 106 may comprise a mist eliminator. Peripheral unit operations include liquid pump 116 and holding tank 118. In some embodiments, pump 116 includes multiple liquid pumps in series or parallel.

Low-pressure gas 130 is drawn into tower 102 through gas inlet/outlet valve 112 by the removal of liquid 144 through liquid outlet valve 114. Gas inlet/outlet valve 112 and liquid outlet valve 114 are then sealed, liquid inlet valve 108 is opened, and liquid pump 116 pumps liquid 140 from holding tank 118 through liquid inlet valve 108 and nozzles 110, spraying 142 into cavity 104, both pressurizing low-pressure gas 130 to produce high-pressure gas 132, and also absorbing substantially all the heat produced due to the pressurization. Once pressurized, liquid inlet valve 108 closes and gas inlet/outlet valve 112 is opened to allow high-pressure gas 132 to leave. At this point, gas inlet/outlet valve 112 is sealed and liquid outlet valve 114 is opened such that liquid 144 passes out of tower 102 into holding tank 118. The cycle is then repeated. In this embodiment, liquid 140 is sprayed 142 via nozzles 110 into cavity 104, the spray aiding in heat absorption due to increased surface area for exchange between liquid 140 and gas 130. In other embodiments, liquid 140 is added without spraying and sufficient time is provided for heat exchange to occur with the reduced surface area that results.

In one embodiment, liquid pump 116 is a centrifugal pump, liquid 140 is water, and gas 130 is flue gas. As the water sprays into the cavity it also contacts the flue gas. In this manner, not only does the water pressurize the flue gas, but also strips acid gases, such as carbon dioxide and sulfur dioxide, from the flue gas. In one embodiment, this occurs substantially isothermally. In another embodiment, the flue gas enters at an elevated temperature and the water provides cooling.

In another embodiment, liquid pump 116 is a diaphragm pump, liquid 140 is 2-methylpentane, and gas 130 is natural gas. In one example, the natural gas comprises carbon dioxide. As the 2-methylpentane sprays into the cavity it also contacts the natural gas. In this manner, not only does the 2-methylpentane pressurize the natural gas, but also strips carbon dioxide from the natural gas. In some embodiments, this occurs substantially isothermally (without changing the temperature of the natural gas, for example).

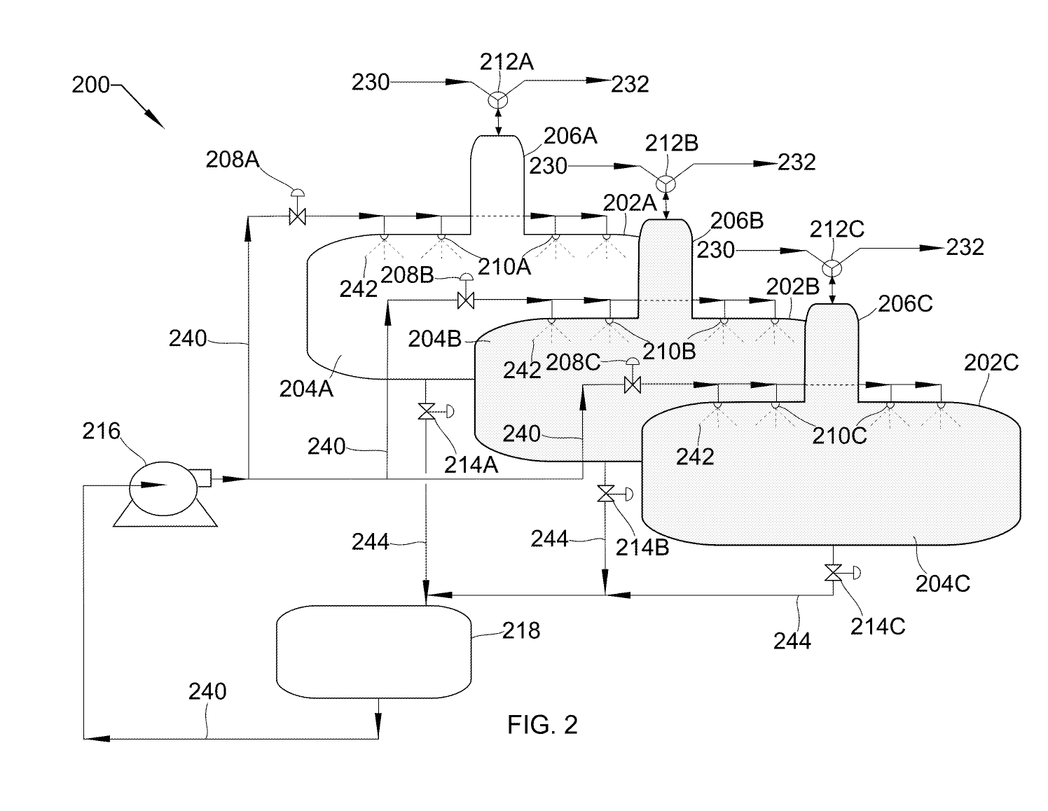

Referring to FIG. 2, FIG. 2 shows a process flow diagram 200 of three horizontal spray towers 202A, 202B, and 202C, in parallel with peripheral unit operations that may be used in the described devices, systems, and methods. Each object and stream parallels the objects in FIG. 1. For example, 202A/B/C are each the same as 102. This parallel occurs throughout FIG. 2, and individual occurrences will not be noted in this text. Horizontal spray towers 202A/B/C consist of cavities 204A/B/C, inverse-boots 206A/B/C, liquid inlet valves 208A/B/C, spray nozzles 210A/B/C, gas inlet/outlet valves 212A/B/C, and liquid outlet valves 214A/B/C. Gas inlet/outlet valves 212 are three-way valves. Peripheral unit operations include liquid pump 216 and holding tank 218.

Low-pressure gas 230 is drawn into towers 202A/B/C through gas inlet/outlet valves 212A/B/C by the removal of liquid 244 through liquid outlet valves 214A/B/C. Gas inlet/outlet valves 212A/B/C and liquid outlet valves 214A/B/C are then sealed, liquid inlet valves 208A/B/C are opened, and liquid pump 216 pumps liquid 240 from holding tank 218 through liquid inlet valves 208A/B/C and nozzles 210A/B/C, spraying 242 into cavity 204A/B/C, both pressurizing low-pressure gas 230 to produce high-pressure gas 232, and also absorbing substantially all the heat produced due to the pressurization. Once pressurized, liquid inlet valves 208A/B/C closes and gas inlet/outlet valves 212A/B/C are opened to allow high-pressure gas 232 to leave. At this point, gas inlet/outlet valves 212A/B/C is sealed and liquid outlet valves 214A/B/C are opened such that liquid 244 passes out of towers 202A/B/C into holding tank 218. The cycle is then repeated.

In some embodiments, the parallel towers 202A/B/C are operated in a staggered, sequential operation to minimize any gaps between production of high-pressure gas 232. In this case, liquid pump 216 runs continually and the cycle described above occurs such that, as high-pressure gas 232 in 202A finishes leaving, high-pressure gas 232 in 202B begins leaving. When 202B is complete, high-pressure gas 232 in 202C begins leaving. When 202C is complete, 202A is ready to begin again. In some embodiments, this smooth pressure requires more than three parallel towers. This could be any number of towers, depending on cycle time, demand, and pressure requirements. In some embodiments, this staggered, sequential system could be used in a carbon capture facility, a refinery, a mineral processing plant, a light gas compression facility, or any facility requiring compression or pressurization of a gas.

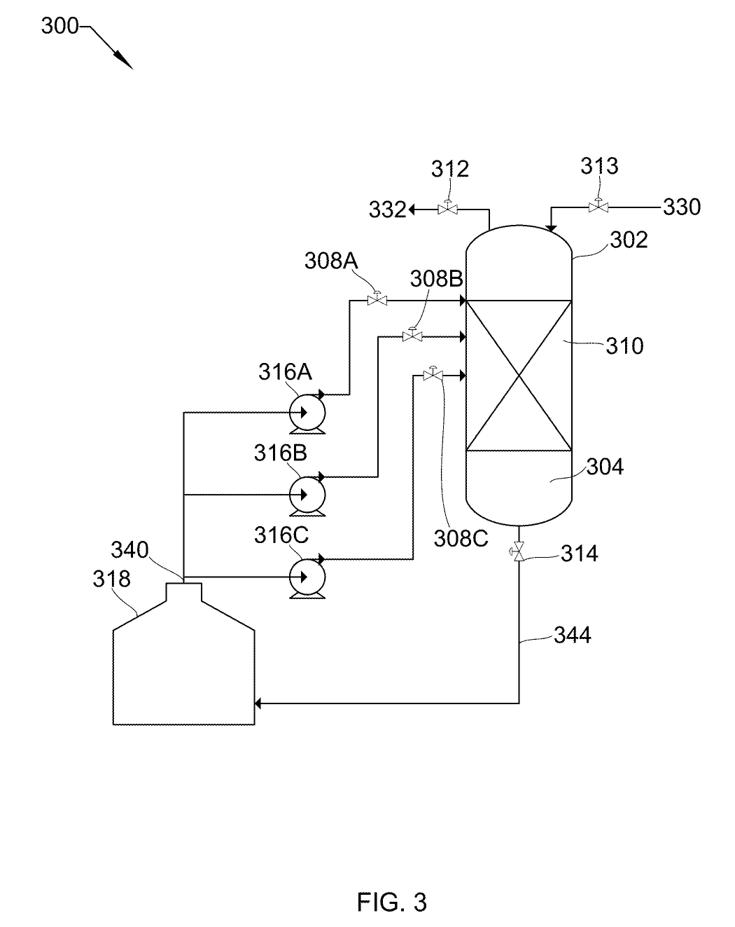

Referring to FIG. 3, FIG. 3 shows a process flow diagram 300 of a vertical spray tower 302 with peripheral unit operations that may be used in the described devices, systems, and methods. Each object and stream parallels the objects in FIG. 1. For example, 302 is the same as 102, except as a vertical spray tower, not a horizontal spray tower. (Vertical spray towers provide greater time for droplets to fall, contacting the gas and exchanging heat. Horizontal spray towers provide more overall area to produce droplets, but the droplets fall for a shorter time.) This parallel occurs throughout FIG. 3, and individual occurrences will not be noted in this text, except where minor changes occur. Vertical spray tower 302 consists of cavity 304, liquid inlet valves 308A/B/C, packing 310 (replacing nozzles 110), gas outlet valve 312 and gas inlet valve 313 (replacing gas inlet/outlet valve 112), and liquid outlet valve 314. Peripheral unit operations include liquid pumps 316A/B/C and holding tank 318. In some embodiments, packing 310 is dense packing. In other embodiments, packing 310 is loose packing. In another embodiment, packing 310 is replaced by baffles.

Low-pressure gas 330 is drawn into tower 302 through gas inlet valve 313 by the removal of liquid 344 through liquid outlet valve 314. Gas inlet valve 313 and liquid outlet valve 314 are then sealed, liquid inlet valves 308A/B/C are opened, and liquid pumps 316A/B/C pump liquid 340 from holding tank 318 through liquid inlet valves 308A/B/C and pass into cavity 304, passing across packing 310. This pressurizes low-pressure gas 330 to produce high-pressure gas 332, and also absorbs substantially all the heat produced due to the pressurization. Once pressurized, liquid inlet valves 308A/B/C close and gas outlet valve 312 is opened to allow high-pressure gas 332 to leave. At this point, gas outlet valve 312 is sealed and liquid outlet valve 314 is opened such that liquid 344 passes out of tower 302 into holding tank 318. The cycle is then repeated.

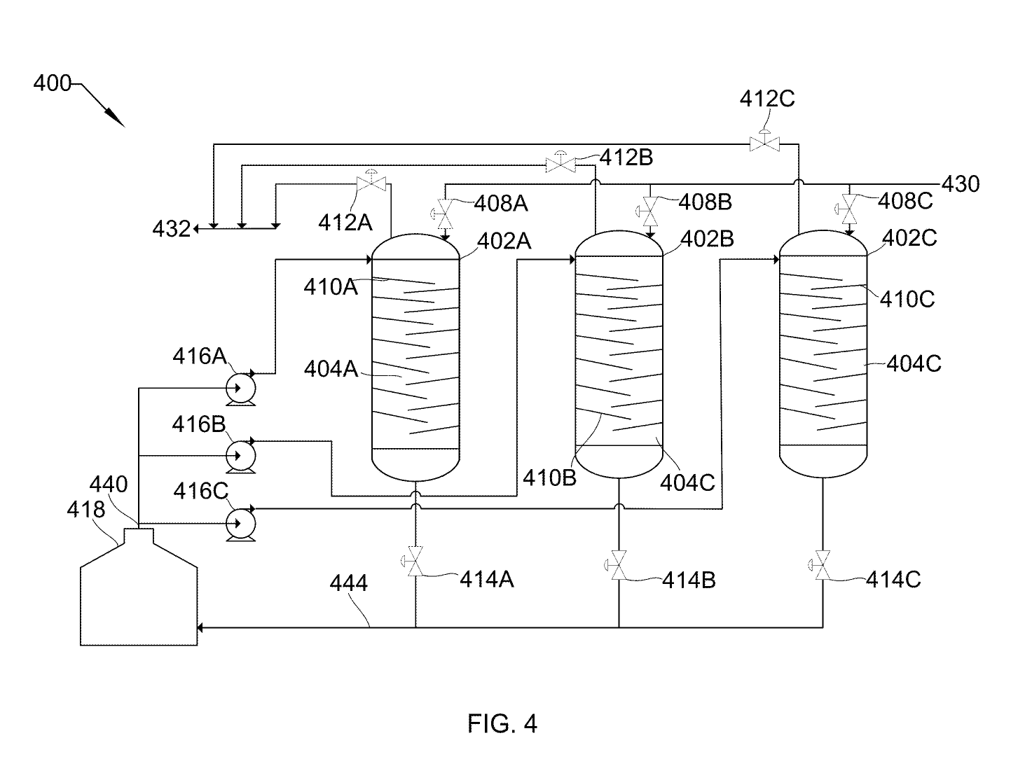

Referring to FIG. 4, FIG. 4 shows a process flow diagram 400 of three vertical spray towers 402A/B/C in parallel with peripheral unit operations that may be used in the described devices, systems, and methods. Each object and stream parallels the objects in FIG. 3. For example, 402 is the same as 302. This parallel occurs throughout FIG. 4, and individual occurrences will not be noted in this text. Vertical spray towers 402A/B/C consist of cavities 404A/B/C, liquid inlet valves 408A/B/C, baffles 410A/B/C, gas outlet valves 412A/B/C, gas inlet valves 413A/B/C, and liquid outlet valves 414A/B/C. Peripheral unit operations include liquid pumps 416A/B/C and holding tank 418.

Low-pressure gas 430 is drawn into towers 402A/B/C through gas inlet valves 413A/B/C by the removal of liquid 444 through liquid outlet valves 414A/B/C. Gas inlet valves 413A/B/C are then sealed, liquid inlet valves 408A/B/C are opened, and liquid pumps 416A/B/C pump liquid 440 from holding tank 418 through liquid inlet valves 408A/B/C and pass into cavities 404A/B/C, passing across baffles 410A/B/C. Baffles 410A/B/C cause the descending liquid 440 to cascade downward in multiple sheeting streams, causing gas 430 to contact liquid 440 at each drop off of baffles 410A/B/C. This pressurizes low-pressure gas 430 to produce high-pressure gas 432, and also absorbs substantially all the heat produced due to the pressurization. Once pressurized, liquid inlet valves 408A/B/C close and gas outlet valves 412A/B/C are opened to allow high-pressure gas 432 to leave. At this point, gas outlet valves 412A/B/C are sealed and liquid outlet valves 414A/B/C are opened such that liquid 444 passes out of towers 402A/B/C into holding tank 418. The cycle is then repeated.

In some embodiments, the parallel towers 402A/B/C are operated in a staggered, sequential operation to minimize any gaps between production of high-pressure gas 432. In this case, liquid pump 416 runs continually and the cycle described above occurs such that, as high-pressure gas 432 in 402A finishes leaving, high-pressure gas 432 in 402B begins leaving. When 402B is complete, high-pressure gas 432 in 402C begins leaving. When 402C is complete, 402A is ready to begin again. In some embodiments, this smooth pressure requires more than three parallel towers. This could be any number of towers, depending on cycle time, demand, and pressure requirements. In some embodiments, this staggered, sequential system could be used in a carbon capture facility, a refinery, a mineral processing plant, a light gas compression facility, or any facility requiring compression or pressurization of a gas.

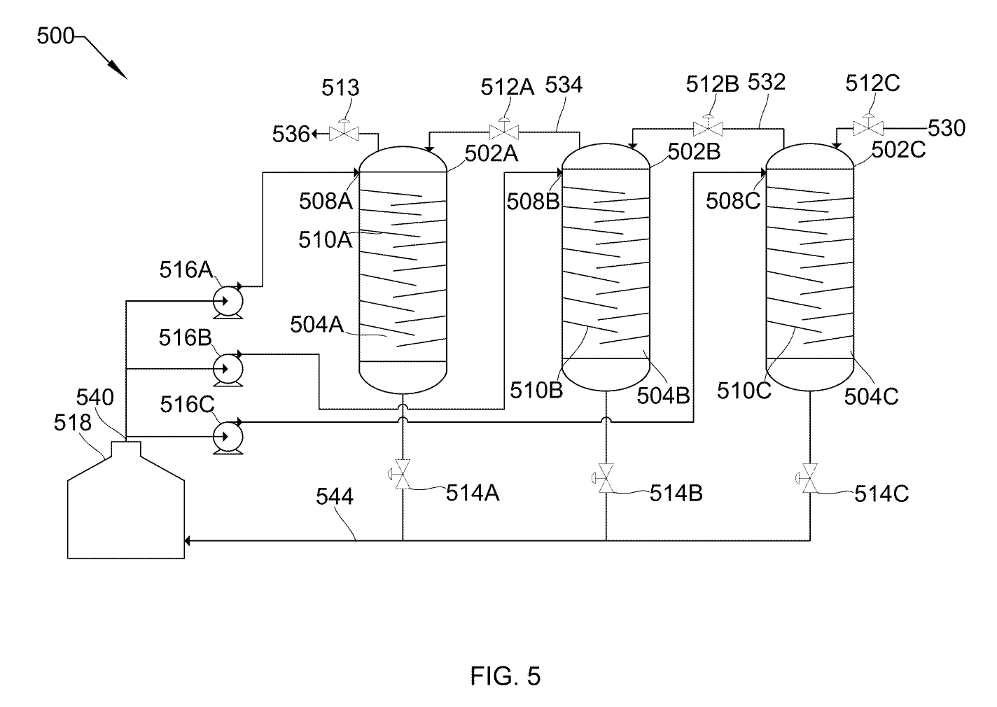

Referring to FIG. 5, FIG. 5 shows a process flow diagram 500 of three vertical spray towers 502A/B/C in series with peripheral unit operations that may be used in the described devices, systems, and methods. Each object and stream parallels the objects in FIG. 3. For example, 502A/B/C are each the same as 302. This parallel occurs throughout FIG. 5, and individual occurrences will be noted when they differ. Vertical spray towers 502A/B/C consist of cavities 504A/B/C, liquid inlets 508A/B/C (rather than valves, as in 308, pumps 516A/B/C provide liquid control), baffles 510A/B/C, gas inlet valve 512C, gas inlet/outlet valves 512A/B, gas outlet valve 513, and liquid outlet valves 514A/B/C. Peripheral unit operations include liquid pumps 516A/B/C and holding tank 518.

Low-pressure gas 530 is drawn into tower 502C through gas inlet valve 512C by the removal of liquid 544 through liquid outlet valves 514C that may be used in the described devices, systems, and methods. Gas inlet valve 512C and liquid outlet valve 514C are then sealed and liquid pump 516C pumps liquid 540 from holding tank 518 into cavity 504C, passing across baffles 510C. This pressurizes low-pressure gas 530 to produce first higher-pressure gas 532, and also absorbs substantially all the heat produced due to the pressurization. This gas becomes the gas feed for tower 502B. Once 502C is pressurized, pump 516C stops and gas inlet/outlet valve 512B is opened to allow first higher-pressure gas 532 to pass into 502B. At this point, gas inlet/outlet valve 512B is sealed and liquid outlet valve 514C is opened such that liquid 544 passes out of tower 502C into holding tank 518.

First higher-pressure gas 532 is drawn into tower 502B through gas inlet/outlet valve 512B by the removal of liquid 544 through liquid outlet valves 514B. Gas inlet/outlet valve 512B and liquid outlet valve 514B are then sealed and liquid pump 516B pumps liquid 540 from holding tank 518 into cavity 504B, passing across baffles 510B. This pressurizes first higher-pressure gas 532 to produce second higher-pressure gas 534, and also absorbs substantially all the heat produced due to the pressurization. This gas becomes the gas feed for tower 502A. Once 502B is pressurized, pump 516B stops and gas inlet/outlet valve 512A is opened to allow second higher-pressure gas 534 to pass into 502A. At this point, gas inlet/outlet valve 512A is sealed and liquid outlet valve 514B is opened such that liquid 544 passes out of tower 502B into holding tank 518.

Second higher-pressure gas 534 is drawn into tower 502A through gas inlet/outlet valve 512A by the removal of liquid 544 through liquid outlet valves 514A. Gas inlet/outlet valve 512A and liquid outlet valve 514A are then sealed and liquid pump 516A pumps liquid 540 from holding tank 518 into cavity 504A, passing across baffles 510A. This pressurizes second higher-pressure gas 534 to produce high-pressure gas 536, and also absorbs substantially all the heat produced due to the pressurization. This gas is the product. Once 502A is pressurized, pump 516A stops and gas outlet valve 513 is opened to allow high-pressure gas 536 to leave. At this point, gas outlet valve 513 is sealed and liquid outlet valve 514A is opened such that liquid 544 passes out of tower 502A into holding tank 518. The cycle is then repeated.

In some embodiments, the series of towers consists of as many towers as is necessary to reach a desired pressure. In some embodiments, a parallel set of a series of towers can be used to both produce higher pressures and steady volumetric flow rates.

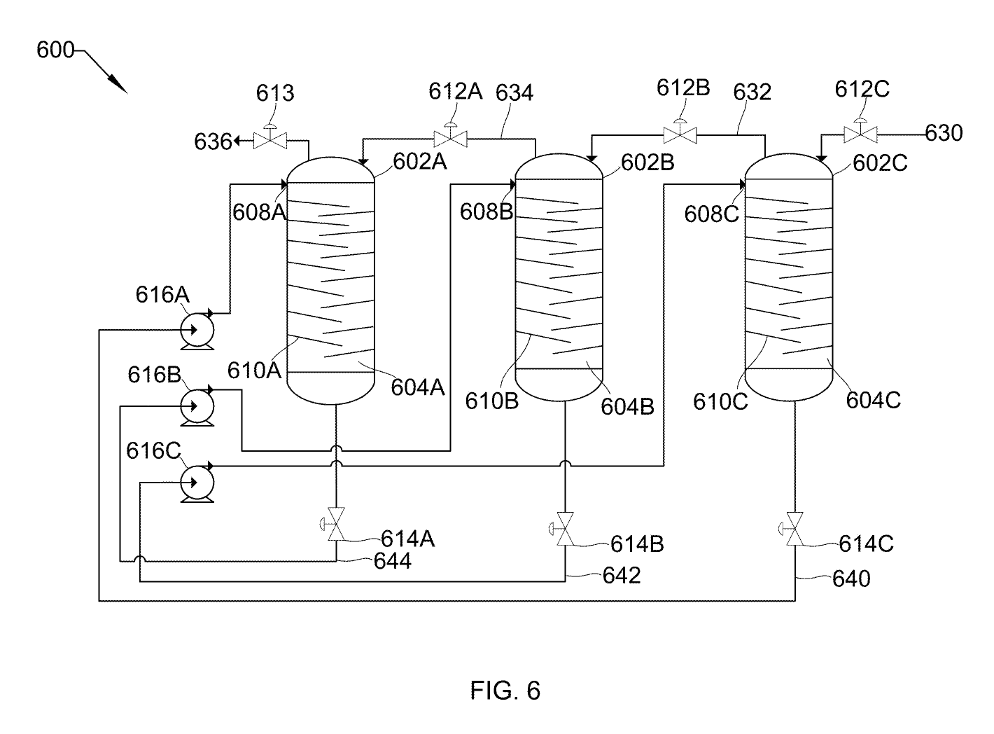

Referring to FIG. 6, FIG. 6 shows a process flow diagram 600 of three vertical spray towers 602A/B/C in series with peripheral unit operations that may be used in the described devices, systems, and methods. Each object and stream parallels the objects in FIG. 5, except as noted. For example, 602A/B/C is the same as 502A/B/C. This parallel occurs throughout FIG. 6, and individual occurrences will be noted when they differ. The most significant difference is the removal of holding tank 518. Vertical spray towers 602A/B/C consist of cavities 604A/B/C, liquid inlets 608A/B/C, baffles 610A/B/C, gas inlet valve 612C, gas inlet/outlet valves 612A/B, gas outlet valve 613, and liquid outlet valves 614A/B/C. Peripheral unit operations include liquid pumps 616A/B/C.

Low-pressure gas 630 is drawn into tower 602C through gas inlet valve 612C by the removal of liquid 640 through liquid outlet valve 614C. Gas inlet valve 612C and liquid outlet valve 614C are then sealed, liquid outlet valve 614B is opened, and liquid pump 616C pumps liquid 642 from tower 602B into cavity 604C, passing across baffles 610C. This pressurizes low-pressure gas 630 to produce first higher-pressure gas 632, and also absorbs substantially all the heat produced due to the pressurization. This gas becomes the gas feed for tower 602B. Once 602C is pressurized, pump 616C stops, liquid outlet valve 614B is sealed, and gas inlet/outlet valve 612B is opened to allow first higher-pressure gas 632 to pass into 602B. At this point, gas inlet/outlet valve 612B is sealed and liquid outlet valve 614C is opened such that liquid 640 can be pumped out of tower 602C by pump 616A.

First higher-pressure gas 632 is drawn into tower 602B through gas inlet/outlet valve 612B by the removal of liquid 642 through liquid outlet valve 614B. Gas inlet/outlet valve 612B and liquid outlet valve 614B are then sealed, liquid outlet valve 614B is opened, and liquid pump 616B pumps liquid 644 from tower 602A into cavity 604B, passing across baffles 610B. This pressurizes first higher-pressure gas 632 to produce second higher-pressure gas 634, and also absorbs substantially all the heat produced due to the pressurization. This gas becomes the gas feed for tower 602A. Once 602B is pressurized, pump 616B stops, liquid outlet valve 614B is sealed, and gas inlet/outlet valve 612A is opened to allow second higher-pressure gas 634 to pass into 602A. At this point, gas inlet/outlet valve 612A is sealed and liquid outlet valve 614B is opened such that liquid 642 can be pumped out of tower 602B by pump 616C.

Second higher-pressure gas 634 is drawn into tower 602B through gas inlet/outlet valve 612A by the removal of liquid 644 through liquid outlet valve 614A. Gas inlet/outlet valve 612A and liquid outlet valve 614A are then sealed, liquid outlet valve 614C is opened, and liquid pump 616A pumps liquid 640 from tower 602C into cavity 604C, passing across baffles 610A. This pressurizes second higher-pressure gas 634 to produce high-pressure gas 636, and also absorbs substantially all the heat produced due to the pressurization. This gas is the product. Once 602A is pressurized, pump 616A stops, liquid outlet valve 614C is sealed, and gas outlet valve 613 is opened to allow high-pressure gas 636 to leave. At this point, gas outlet valve 613 is sealed and liquid outlet valve 614A is opened such that liquid 644 can be pumped out of tower 602A by pump 616B. The cycle is then repeated.

In some embodiments, liquid 640, 642, and 644 will pass through heat exchangers after pumps 616A, 616B, and 616C, respectively, to maintain liquid temperature. In some embodiments, make-up liquid will be added to the system to recover any liquid lost to evaporation.

In some embodiments, check valves are used downstream of pumps, control valves, or both to prevent back flow. In some embodiments, combined check and pressure regulating valves are used on the final outlet of the system such that high-pressure gas is able to leave as it is made, rather than waiting through an entire cycle. In some embodiments, the pump runs continuously, deadheading against closed valves when shut, but providing immediate flow when valves open.

In some embodiments, the vessel may comprise spray towers, packed tower, distillation columns, or a combination thereof.

In some embodiments, the liquid may be water, hydrocarbons, liquid ammonia, liquid carbon dioxide, cryogenic liquids, or combinations thereof. The hydrocarbons may be 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl -1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

In some embodiments, the liquid further contains an entrained solid. The entrained solid can contain soot, dust, minerals, microbes, solid carbon dioxide, solid nitrogen oxide, solid sulfur dioxide, solid nitrogen dioxide, solid sulfur trioxide, solid hydrogen sulfide, solid hydrogen cyanide, ice, solid hydrocarbons, precipitated salts, or combinations thereof.

In some embodiments, the gas may be flue gas, syngas, producer gas, natural gas, steam reforming gas, hydrocarbons, light gases, refinery off-gases, organic solvents, steam, ammonia, or combinations thereof. The gas may further contain carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

The liquid may be a mixture consisting of a solvent and either an ionic compound or soluble organic compound. The ionic compounds can be potassium carbonate, potassium formate, potassium acetate, calcium magnesium acetate, magnesium chloride, sodium chloride, lithium chloride, and calcium chloride. The soluble organic compounds can be glycerol, ammonia, propylene glycol, ethylene glycol, ethanol, and methanol. The solvent may be water, hydrocarbons, liquid ammonia, liquid carbon dioxide, cryogenic liquids, or combinations thereof.

In some embodiments, the compression occurs substantially isothermally.

In some embodiments, the liquid inlet may be a spray nozzle, the spray nozzle causing the liquid entering the vessel to form a spray. In other embodiments, the liquid inlet may be any device that maximizes gas/liquid heat transfer.

In some embodiments, the gas is a vapor and the liquid strips the vapor from the gas. In some embodiments, passing the high-pressure gas out of the one or more vessels is staggered such that each of the one or more vessels passes the high-pressure gas out at off-set times to produce a flow rate of the high-pressure gas that remains substantially steady.

In some embodiments, the one or more vessels are arranged in series, with the destination gas outlet of a previous vessel being the source gas outlet for a next vessel such that a final pressure of each of the one or more vessels is higher than a final pressure of a previous of the one or more vessels.

In some embodiments, the source gas inlet and the destination gas outlet meet at a three-way valve, the liquid inlet and the liquid outlet meet at a three-way valve, or a combination thereof.

In some embodiments, the vessel has a mist eliminator before the destination gas outlet.

In some embodiments, the source gas inlet, the destination gas outlet, the liquid inlet, and the liquid outlet comprise control valves.

In some embodiments, the liquid consists of water, liquid ammonia, hydrocarbons, cryogenic liquids, or combinations thereof. In some embodiments, the gas consists of air, flue gas, syngas, producer gas, natural gas, steam reforming gas, hydrocarbons, light gases, refinery off-gases, organic solvents, steam, ammonia, or combinations thereof. In some embodiments, the liquid is chosen to regulate the total amount of vapor that forms in the gas. For example, a non-volatile liquid may be used to compress a gas, resulting in substantially no liquid vaporizing into the gas.

1. A method for compressing a gas comprising:
drawing a low-pressure gas into a vessel through a source gas inlet;
sealing the source gas inlet and a liquid gas outlet;
pumping a liquid into the vessel through a liquid inlet such that the low-pressure gas is compressed to produce a high-pressure gas;
sealing the liquid inlet;
opening a destination gas outlet and passing the high-pressure gas out of the vessel;
sealing the destination gas outlet;
opening the source gas inlet;
opening the liquid outlet and removing the liquid out of the vessel such that the low-pressure gas is drawn into the vessel as the liquid is removed out of the vessel.

2. The method of claim 1, wherein compression occurs substantially isothermally.

3. The method of claim 1, wherein the liquid inlet comprises a spray nozzle, the spray nozzle causing the liquid entering the vessel to form a spray.

4. The method of claim 2, wherein the gas comprises a vapor and the liquid strips the vapor from the gas.

5. The method of claim 1, wherein the vessel comprises a plurality of vessels and passing the high-pressure gas out of the plurality of vessels is staggered such that each of the plurality of vessels passes the high-pressure gas out at off-set times to produce a flow rate of the high-pressure gas that remains substantially steady.

6. The method of claim 1, wherein the vessel comprises a plurality of vessels arranged in series with the destination gas outlet of a previous vessel of the plurality of vessels being the source gas outlet for a next vessel of the plurality of vessels such that a final pressure of each of the plurality of vessels is higher than a final pressure of the previous vessel of the plurality of vessels.

7. The method of claim 1, wherein the source gas inlet and the destination gas outlet meet at a three-way valve, the liquid inlet and the liquid outlet meet at a three-way valve, or a combination thereof.

8. The method of claim 1, wherein the vessel comprises an inverse-boot.

9. The method of claim 1, wherein the vessel comprises a mist eliminator before the destination gas outlet.

10. The method of claim 1, wherein the source gas inlet, the destination gas outlet, the liquid inlet, and the liquid outlet comprise control valves.

11. A system for compressing a gas, comprising:
a liquid pump;
21
a vessel comprising a source gas inlet, a destination gas outlet, a liquid inlet, and a liquid outlet, wherein:
a low-pressure gas is drawn into the vessel through the source gas inlet,
the source gas inlet and a liquid outlet are sealed;
a liquid is pumped by the liquid pump into the vessel through a liquid inlet such that the low-pressure gas is compressed to produce a high-pressure gas;
the liquid inlet is sealed;
a destination gas outlet is opened and the high-pressure gas is passed out of the vessel;
the destination gas outlet is sealed;
the source gas inlet is opened;
a liquid outlet is opened and the liquid is removed out of the vessel such that the low-pressure gas is drawn into the vessel.

12. The system of claim 11, wherein compression occurs substantially isothermally.

13. The system of claim 11, wherein the liquid inlet comprises a spray nozzle, the spray nozzle causing the liquid entering the vessel to form a spray.

14. The system of claim 12, wherein the gas comprises a vapor and the liquid strips the vapor from the gas.

15. The system of claim 1, wherein the vessel comprises a plurality of vessels and the high-pressure gas is passed out of the plurality of vessels such that each of the plurality of vessels passes the high-pressure gas out at off-set times to produce a flow rate of the high-pressure gas that remains substantially steady.

16. The system of claim 1, wherein the vessel comprises a plurality of vessels arranged in series, with the destination gas outlet of a previous vessel of the plurality of vessels being the source gas outlet for a next vessel of the plurality of vessels, such that a final pressure of each of the plurality of vessels is higher than a final pressure of the previous vessel of the plurality of vessels.

17. The system of claim 11, wherein the source gas inlet and the destination gas outlet meet at a three-way valve, the liquid inlet and the liquid outlet meet at a three-way valve, or a combination thereof.

18. The system of claim 11, wherein the vessel comprises an inverse-boot.

19. The system of claim 11, wherein the vessel comprises a mist eliminator before the destination gas outlet.

20. The system of claim 11, wherein the source gas inlet, the destination gas outlet, the liquid inlet, and the liquid outlet comprise control valves.
